(19) United States
(12) Patent Application Publication
(10) Pub. No.: US 2024/0028370 A1
(43) Pub. Date: Jan. 25, 2024

(54) DIAGNOSING REMOTE SITES OF A DISTRIBUTED CONTAINER ORCHESTRATION SYSTEM

(71) Applicant: VMware, Inc., Palo Alto, CA (US)

(72) Inventors: Jian LAN, Beijing (CN); Liang CUI, Beijing (CN); Qi WANG, Beijing (CN); Aravind SRINIVASAN, Sunnyvale, CA (US); Todd SABIN, Morganville, NJ (US); Govind HARIDAS, San Jose, CA (US); Weiqing WU, Cupertino, CA (US); Uday Suresh MASUREKAR, Sunnyvale, CA (US); Wenwu PENG, Beijing (CN); Ni LU, Beijing (CN)

(21) Appl. No.: 17/902,327

(22) Filed: Sep. 2, 2022

(30) Foreign Application Priority Data
Jul. 21, 2022 (WO) PCT/CN2022/106972

(51) Int. Cl. G06F 9/455; G06F 9/50; G06F 11/36

(52) U.S. Cl. CPC G06F 9/45558; G06F 9/5077; G06F 11/36; G06F 2009/4557

(57) ABSTRACT

An example method of diagnosing remote sites of a distributed container orchestration system includes: receiving, at a management cluster, definition of a test suite custom resource; deploying, in response to the test suite custom resource, a first pod in the management cluster; deploying, by the first pod, a second pod in a server of a first remote site of the remote sites; checking, by the second pod, configuration of the server that includes an additional pod executing alongside the second pod, at least one virtual machine (VM) in which the second pod and the additional pod execute, a hypervisor configured to support the at least one VM, and a hardware platform on which the hypervisor executes; and returning test data from the second pod to the first pod, the test data including results of the step of checking the configuration of the server.

### CROSS-REFERENCE

This application is based upon and claims the benefit of priority from International Patent Application No. PCT/CN2022/106972, filed on Jul. 21, 2022, the entire contents of which are incorporated herein by reference.

### BACKGROUND

Applications today are deployed onto a combination of virtual machines (VMs), containers, application services, and more. For deploying such applications, a container orchestrator (CO) known as Kubernetes® has gained in popularity among application developers. Kubernetes provides a platform for automating deployment, scaling, and operations of application containers across clusters of hosts. It offers flexibility in application development and offers several useful tools for scaling.

In a Kubernetes system, containers are grouped into logical unit called “pods” that execute on nodes in a cluster (also referred to as “node cluster”). Containers in the same pod share the same resources and network and maintain a degree of isolation from containers in other pods. The pods are distributed across nodes of the cluster. In a typical deployment, a node includes an operating system (OS), such as Linux®, and a container engine executing on top of the OS that supports the containers of the pod. A node can be a physical server or a VM.

In a radio access network (RAN) deployment, such as a 5G RAN deployment, cell site network functions can be realized as Kubernetes pods. Each cell site can be deployed with a single server. To support network functions at the cell sites, the servers include various customizations to basic input output system (BIOS), firmware, drivers, hypervisors, virtual machines (VMs), guest operating systems, and the like. Incorrect configuration of one or more of such components can cause the network functions to fail, exhibit unintended latency, or otherwise perform inefficiently or incorrectly. A further complication is the large scale of a typical RAN. In a 5G deployment, for example, there can be more than 10,000 remote cell sites managed by a centralized control plane. This requires diagnosis of a large number of servers to ensure correct configuration.

### SUMMARY

Embodiments include a method of diagnosing remote sites of a distributed container orchestration system. The method includes: receiving, at a management cluster, definition of a test suite custom resource; deploying, in response to the test suite custom resource, a first pod in the management cluster; deploying, by the first pod, a second pod in a server of a first remote site of the remote sites; checking, by the second pod, configuration of the server that includes an additional pod executing alongside the second pod, at least one virtual machine (VM) in which the second pod and the additional pod execute, a hypervisor configured to support the at least one VM, and a hardware platform on which the hypervisor executes; and returning test data from the second pod to the first pod, the test data including results of the step of checking the configuration of the server.

Further embodiments include a non-transitory computer-readable storage medium comprising instructions that cause a computer system to carry out the above methods, as well as a computer system configured to carry out the above methods.

### BRIEF DESCRIPTION OF THE DRAWINGS

FIG. 1 is a block diagram of a virtualized computing system in which embodiments described herein may be implemented.

FIG. 2 is a block diagram depicting a server of a site in a distributed container orchestration system according to embodiments.

FIG. 3 is a block diagram depicting state of virtualized computing system during site diagnosis according to embodiments.

FIG. 4 is a flow diagram depicting a method of diagnosing configuration of remote sites in a distributed container orchestration system according to embodiments.

### DETAILED DESCRIPTION

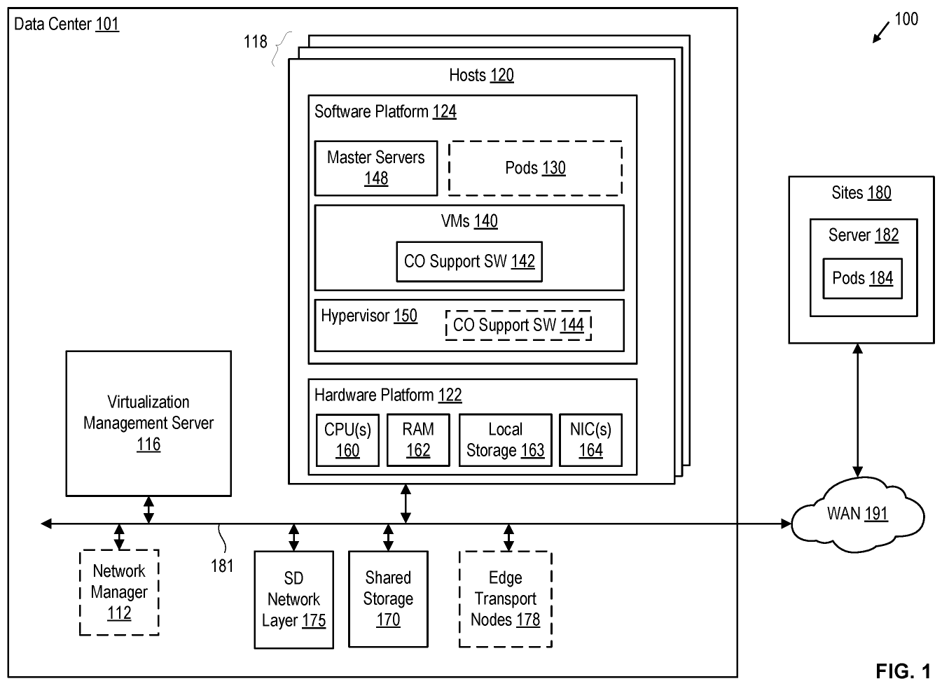

FIG. 1 is a block diagram of a virtualized computing system 100 in which embodiments described herein may be implemented. Virtualized computing system includes a data center 101 in communication with a plurality of sites 180 through a wide area network (WAN) 191 (e.g., the public Internet). Sites 180 can be geographical dispersed with respect to each other and with respect to data center 101. For example, sites 180 can be part of a radio access network (RAN) dispersed across a geographic region and serving different portions of such geographic region. In embodiments, data center 101 comprises a software-defined data center (SDDC) deployed in a cloud, such as a public cloud, private cloud, or multi-cloud system (e.g., a hybrid cloud system). In other embodiments, data center 101 can be deployed by itself outside of any cloud environment.

Data center 101 includes hosts 120. Hosts 120 may be constructed on hardware platforms such as an x86 architecture platforms. One or more groups of hosts 120 can be managed as clusters 118. As shown, a hardware platform 122 of each host 120 includes conventional components of a computing device, such as one or more central processing units (CPUs) 160, system memory (e.g., random access memory (RAM) 162), one or more network interface controllers (NICs) 164, and optionally local storage 163. CPUs 160 are configured to execute instructions, for example, executable instructions that perform one or more operations described herein, which may be stored in RAM 162. NICs 164 enable host 120 to communicate with other devices through a physical network 181. Physical network 181 enables communication between hosts 120 and between other components and hosts 120 (other components discussed further herein).

In the embodiment illustrated in FIG. 1, hosts 120 access shared storage 170 by using NICs 164 to connect to network 181. In another embodiment, each host 120 contains a host bus adapter (HBA) through which input/output operations (IOs) are sent to shared storage 170 over a separate network (e.g., a fibre channel (FC) network). Shared storage 170 include one or more storage arrays, such as a storage area network (SAN), network attached storage (NAS), or the like. Shared storage 170 may comprise magnetic disks, solid-state disks, flash memory, and the like as well as combinations thereof. In some embodiments, hosts 120 include local storage 163 (e.g., hard disk drives, solid-state drives, etc.). Local storage 163 in each host 120 can be aggregated and provisioned as part of a virtual SAN, which is another form of shared storage 170.

A software platform 124 of each host 120 provides a virtualization layer, referred to herein as a hypervisor 150, which directly executes on hardware platform 122. In an embodiment, there is no intervening software, such as a host operating system (OS), between hypervisor 150 and hardware platform 122. Thus, hypervisor 150 is a Type-1 hypervisor (also known as a “bare-metal” hypervisor). As a result, the virtualization layer in host cluster 118 (collectively hypervisors 150) is a bare-metal virtualization layer executing directly on host hardware platforms. Hypervisor 150 abstracts processor, memory, storage, and network resources of hardware platform 122 to provide a virtual machine execution space within which multiple virtual machines (VM) 140 may be concurrently instantiated and executed. One example of hypervisor 150 that may be configured and used in embodiments described herein is a VMware ESXI™ hypervisor provided as part of the VMware vSphere® solution made commercially available by VMware, Inc. of Palo Alto, CA.

Virtualized computing system 100 is configured with a software-defined (SD) network layer 175. SD network layer 175 includes logical network services executing on virtualized infrastructure of hosts 120. The virtualized infrastructure that supports the logical network services includes hypervisor-based components, such as resource pools, distributed switches, distributed switch port groups and uplinks, etc., as well as VM-based components, such as router control VMs, load balancer VMs, edge service VMs, etc. Logical network services include logical switches and logical routers, as well as logical firewalls, logical virtual private networks (VPNs), logical load balancers, and the like, implemented on top of the virtualized infrastructure. In embodiments, virtualized computing system 100 includes edge transport nodes 178 that provide an interface of host cluster 118 to WAN 191. Edge transport nodes 178 can include a gateway (e.g., implemented by a router) between the internal logical networking of host cluster 118 and the external network. Edge transport nodes 178 can be physical servers or VMs. Virtualized computing system 100 also includes physical network devices (e.g., physical routers/switches) as part of physical network 181, which are not explicitly shown.

Virtualization management server 116 is a physical or virtual server that manages hosts 120 and the hypervisors therein. Virtualization management server 116 installs agent(s) in hypervisor 150 to add a host 120 as a managed entity. Virtualization management server 116 can logically group hosts 120 into host cluster 118 to provide cluster-level functions to hosts 120, such as VM migration between hosts 120 (e.g., for load balancing), distributed power management, dynamic VM placement according to affinity and anti-affinity rules, and high-availability. The number of hosts 120 in host cluster 118 may be one or many. Virtualization management server 116 can manage more than one host cluster 118. While only one virtualization management server 116 is shown, virtualized computing system 100 can include multiple virtualization management servers each managing one or more host clusters.

In an embodiment, virtualized computing system 100 further includes a network manager 112. Network manager 112 is a physical or virtual server that orchestrates SD network layer 175. In an embodiment, network manager 112 comprises one or more virtual servers deployed as VMs. Network manager 112 installs additional agents in hypervisor 150 to add a host 120 as a managed entity, referred to as a transport node. One example of an SD networking platform that can be configured and used in embodiments described herein as network manager 112 and SD network layer 175 is a VMware NSX® platform made commercially available by VMware, Inc. of Palo Alto, CA. In other embodiments, SD network layer 175 is orchestrated and managed by virtualization management server 116 without the presence of network manager 112.

In embodiments, sites 180 perform software functions using containers. For example, in a RAN, sites 180 can include container network functions (CNFs) deployed as pods 184 by a container orchestrator (CO), such as Kubernetes. The CO control plane includes a master server 148 executing in host(s) 120. A master server 148 can execute in VM(s) 140 and includes various components, such as an application programming interface (API), database, controllers, and the like. A master server 148 is configured to deploy and manage pods 184 executing in sites 180. In some embodiments, a master server 148 can also deploy pods 130 on hosts 120 (e.g., in VMs 140). At least a portion of hosts 120 comprise a management cluster having master servers 148 and pods 130.

In embodiments, VMs 140 include CO support software 142 to support execution of pods 130. CO support software 142 can include, for example, a container runtime, a CO agent (e.g., kubelet), and the like. In some embodiments, hypervisor 150 can include CO support software 144. In embodiments, hypervisor 150 is integrated with a container orchestration control plane, such as a Kubernetes control plane. This integration provides a “supervisor cluster” (i.e., management cluster) that uses VMs to implement both control plane nodes and compute objects managed by the Kubernetes control plane. For example, Kubernetes pods are implemented as “pod VMs,” each of which includes a kernel and container engine that supports execution of containers. The Kubernetes control plane of the supervisor cluster is extended to support VM objects in addition to pods, where the VM objects are implemented using native VMs (as opposed to pod VMs). In such case, CO support software 144 can include a CO agent that cooperates with a master server 148 to deploy pods 130 in pod VMs of VMs 140.

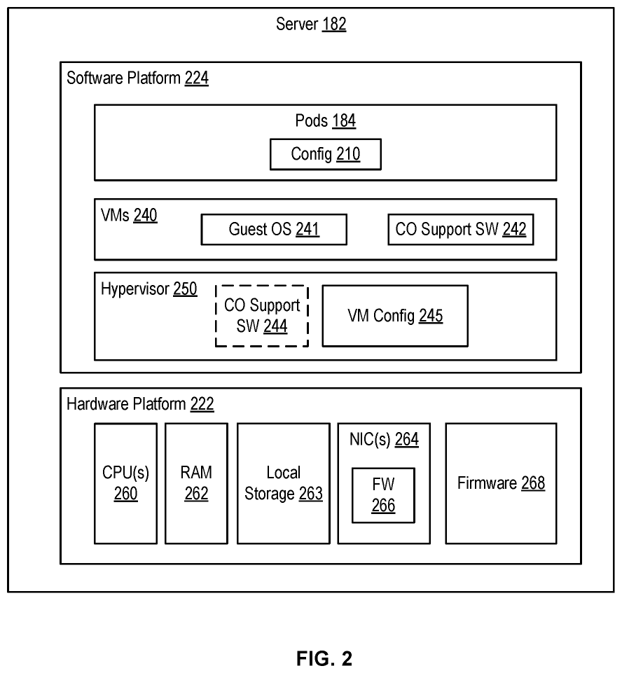

FIG. 2 is a block diagram depicting a server 182 of a site 180 according to embodiments. Server 182 may be constructed on a hardware platform such as an x86 architecture platform. As shown, a hardware platform 222 of server 182 includes conventional components of a computing device, such as one or more CPUs 260, system memory (e.g., RAM 262), one or more NICs 264, firmware 268 (e.g., BIOS or the like), and local storage 263. CPUs 260 are configured to execute instructions, for example, executable instructions that perform one or more operations described herein, which may be stored in RAM 262. NICs 264 enable server 182 to communicate with other devices (i.e., data center 101). In the example, NICs 264 have firmware 266.

A software platform 224 of server 182 includes a hypervisor 250, which directly executes on hardware platform 222. In an embodiment, there is no intervening software, such as a host OS, between hypervisor 250 and hardware platform 222. Thus, hypervisor 250 is a Type-1 hypervisor (also known as a “bare-metal” hypervisor). Hypervisor 150 supports multiple VMs 240, which may be concurrently instantiated and executed. Pods 184 execute in VMs 240 and have a configuration 210. For example, pods 184 can execute network functions (e.g., containerized network functions (CNFs)). In embodiments, VMs 240 include CO support software 242 and a guest operating system (OS) 241 to support execution of pods 184. CO support software 242 can include, for example, a container runtime, a CO agent (e.g., kubelet), and the like. Guest OS 241 can be any commercial operating system (e.g., Linux®). In some embodiments, hypervisor 250 can include CO support software 244 that functions as described above with hypervisor 150. Hypervisor 250 can maintain VM config data 245 for VMs 240.

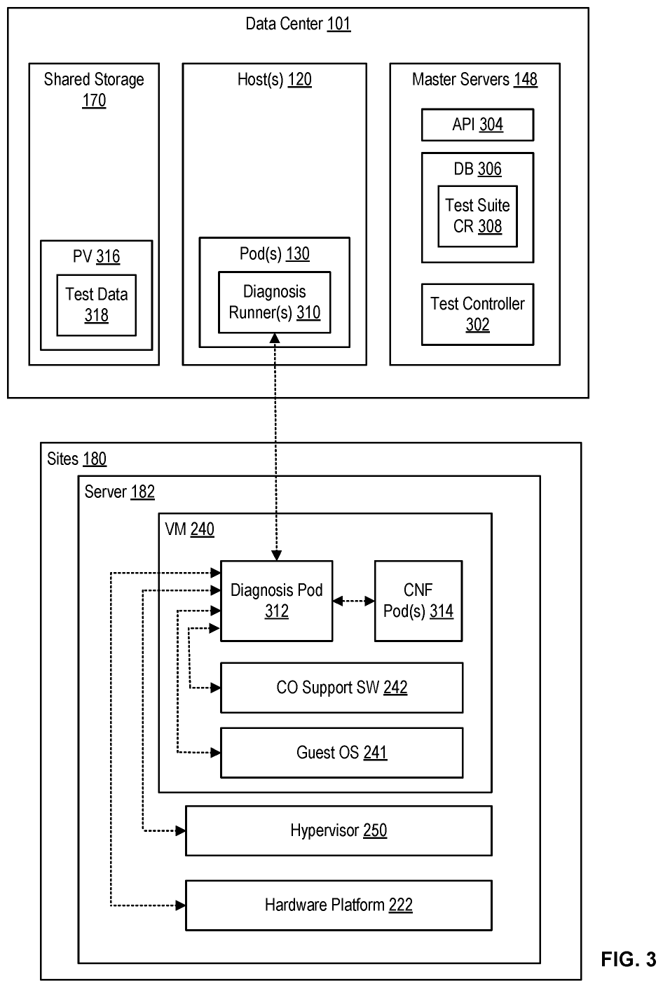

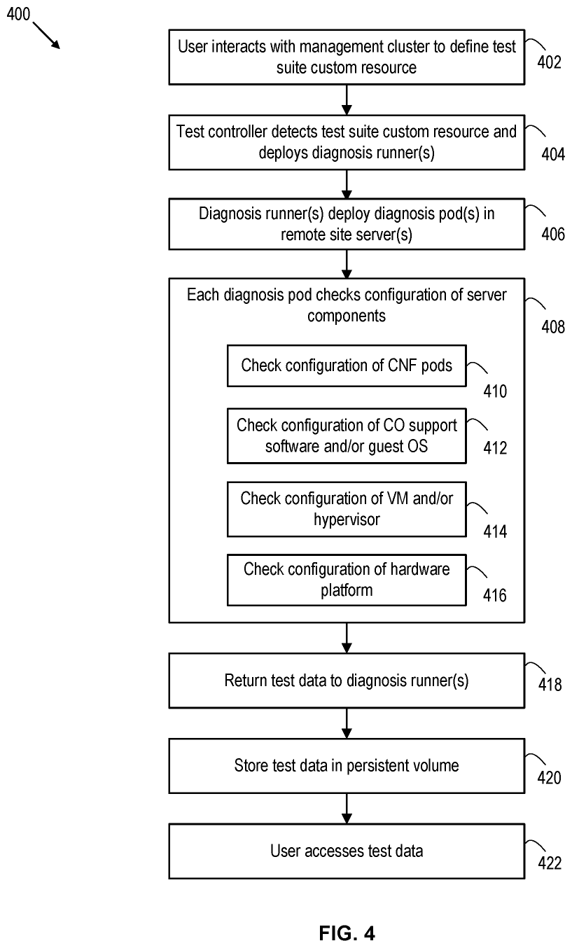

FIG. 3 is a block diagram depicting state of virtualized computing system during site diagnosis according to embodiments. Master servers 148 in data center 101 include an application programming interface (API) 304, a database (DB) 306, and a test controller 302. API 304 provides an interface to master servers 148 for users and/or software (e.g., kube-api server). Database 306 is configured to store state of the cluster. A user can interact with API 304 to define a test suite custom resource (CR) 308. Test suite CR 308 defines in a declarative way diagnoses to be performed on sites 180. In embodiments, test suite CR defines an image to be used for a diagnosis runner and information for defining which sites to be diagnosed. Test controller 302 detects test suite CR 308 and deploys one or more diagnosis runners 310 in pod(s) 130 on host(s) 120 of the management cluster. Diagnosis runner(s) 310 deploy diagnosis pods 312 in sites 180 as instructed by test controller 302 (and specified by the user in test suite CR 308). In a server, diagnosis pod 312 is deployed in a VM 240 and executes alongside other pods, such as CNF pods 314. Diagnosis pod 312 communicates with CO support software 242, guest OS 241, hypervisor 250, and hardware platform 222 to diagnose configurations thereof and obtain test data. Diagnosis pod 312 returns the test data to diagnosis runner(s) 310, which in turn forwards the test data to test controller 302. Test controller 302 persists test data 318 in a persistent volume 316 stored in shared storage 170. A user can access test data 318 to detect any misconfigurations in servers 182 of sites 180. The diagnosis process is discussed in more detail below with respect to FIG. 4.

FIG. 4 is a flow diagram depicting a method of diagnosing configuration of remote sites in a distributed container orchestration system according to embodiments. Method 400 can be understood with respect to FIG. 3. Method 400 begins at step 402, where a user interacts with the management cluster to define a test suite custom resource. For example, as shown in FIG. 3, a user interacts with API 304 to define test suite CR 308. An example test suite CR is shown below:

apiVersion: testnftelco.vmware.com/v1
kind: TcaTestSuite
metadata:
name: wc2-node-diagnosis
   spec:
cases:
   name: tca diagnosis
   steps:
      name: tca diagnosis
      persistOutputDetails: true
      runner:
         args:
         node-diagnose
         image: vmwtec.jfrog.io/docker-devitca-diagnosis-runner:1.5.0-dev
      targets:
   selectors:
      labels:
         tanzu.vmware.com/cluster-name=wc2
   type: NODE

In the example, the test suite CR declares that the test data is to be stored in persistent volume 316 (e.g., “persistOutputDetails: true”). The test suite CR defines arguments for diagnosis runner 310 (e.g., “node-diagnose”) and defines an image to be used (e.g., “vmwtec.jfrog.io/docker-dev/tca-diagnosis-runner:1.5.0-dev”). The test suite CR further defines selectors and labels to specify which sites 180 to be diagnosed (e.g., “tanzu.vmware.com/cluster-name=wc2”).

At step 404, test controller 302 detects test suite CR 308 and deploys one or more diagnosis runners 310 as pod(s) 130 in the management cluster. Test controller 302 can deploy diagnosis runner(s) 310 based on an image specified in test suite CR 308 and using arguments specified in test suite CR 308. Test controller 302 also provides information on which sites 180 to be diagnosed as specified in test suite CR 308. Diagnosis runners are configured to deploy diagnosis pods at the sites and collect test data returned from the diagnosis pods.

At step 406, diagnosis runner(s) 310 deploy diagnosis pods 312 to servers 182 of selected sites 180. In embodiments, diagnosis pod 312 is lightweight and is deleted after the diagnosis process is complete. Diagnosis pod 312 requires minimal resources of server 182 to mitigate performance impact on executing CNFs in CNF pods 314.

At step 408, each diagnosis pod 312 checks the configuration of server components of its respective server 182. Configuration of a server defines its state in terms of software and hardware. For example, at step 410, a diagnosis pod 312 checks configuration of CNF pods 314. Pod configuration defines state of CNF pods 314, such as enabled features, disabled features, version information, and the like. At step 412, a diagnosis pod 312 checks configuration of CO support software 242 and/or guest OS 241 (“node configuration”). Node configuration describes the state of CO support software 242 and/or guest OS 241 and can include, for example, guest OS version information, packages installed, kernel arguments used, kernel modules used, and the like. At step 414, a diagnosis pod 312 checks configuration of VM 240 and/or hypervisor 250. Such configuration describes the state of hypervisor 250 and VM 240 and can include, for example, CPU pinning information, memory optimization information, hyper-threading information, and the like. At step 416, a diagnosis pod 312 checks configuration of hardware platform 222. Such configuration describes the state of hardware platform 222, such as features enabled/disabled in firmware 268, features enabled/disabled in firmware 266, firmware settings, firmware version information, and the like.

At step 418, each diagnosis pod 312 returns test data to diagnosis runner(s) 310. The test data includes results of the checks diagnosis checks performed in step 408. The test data can include status information (e.g., pass/fail for each check), report/log information, and the like. At step 420, test controller 302 receives the test data from diagnosis runner(s) 310 and stores test data in PV 316. At step 422, a user can access test data 318 to verify proper operation and identify any misconfiguration in sites 180.

One or more embodiments of the invention also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations.

The embodiments described herein may be practiced with other computer system configurations including hand-held devices, microprocessor systems, microprocessor-based or programmable consumer electronics, minicomputers, mainframe computers, etc.

One or more embodiments of the present invention may be implemented as one or more computer programs or as one or more computer program modules embodied in computer readable media. The term computer readable medium refers to any data storage device that can store data which can thereafter be input to a computer system. Computer readable media may be based on any existing or subsequently developed technology that embodies computer programs in a manner that enables a computer to read the programs. Examples of computer readable media are hard drives, NAS systems, read-only memory (ROM), RAM, compact disks (CDs), digital versatile disks (DVDs), magnetic tapes, and other optical and non-optical data storage devices. A computer readable medium can also be distributed over a network-coupled computer system so that the computer readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation unless explicitly stated in the claims.

Virtualization systems in accordance with the various embodiments may be implemented as hosted embodiments, non-hosted embodiments, or as embodiments that blur distinctions between the two. Furthermore, various virtualization operations may be wholly or partially implemented in hardware. For example, a hardware implementation may employ a look-up table for modification of storage access requests to secure non-disk data.

Many variations, additions, and improvements are possible, regardless of the degree of virtualization. The virtualization software can therefore include components of a host, console, or guest OS that perform virtualization functions.

Plural instances may be provided for components, operations, or structures described herein as a single instance. Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined structure or component. Similarly, structures and functionalities presented as a single component may be implemented as separate components. These and other variations, additions, and improvements may fall within the scope of the appended claims.

What is claimed is:

1. A method of diagnosing remote sites of a distributed container orchestration system, comprising:
receiving, at a management cluster, definition of a test suite custom resource;
deploying, in response to the test suite custom resource, a first pod in the management cluster;
deploying, by the first pod, a second pod in a server of a first remote site of the remote sites;
checking, by the second pod, configuration of the server that includes an additional pod executing alongside the second pod, at least one virtual machine (VM) in which the second pod and the additional pod execute, a hypervisor configured to support the at least one VM, and a hardware platform on which the hypervisor executes; and
returning test data from the second pod to the first pod, the test data including results of the step of checking the configuration of the server.

2. The method of claim 1, wherein the management cluster executes in a data center remote from the remote sites, and wherein the management cluster includes a master server having a test controller configured to detect the test suite custom resource and to deploy the first pod based on the test suite custom resource.

3. The method of claim 2, wherein the test controller receives the test data from the first pod and stores the test data in a persistent volume attached to the test controller.

4. The method of claim 1, wherein the configuration of the server includes configuration of the additional pod.

5. The method of claim 1, wherein the configuration of the server includes configuration of at least one of container orchestrator support software or a guest operating system executing in the VM.

6. The method of claim 1, wherein the configuration of the server includes configuration of the hypervisor.

7. The method of claim 1, wherein the configuration of the server includes configuration of the hardware platform as determined from firmware of the hardware platform.

8. A non-transitory computer readable medium comprising instructions to be executed in a computing device to cause the computing device to carry out a method of diagnosing remote sites of a distributed container orchestration system, comprising:
receiving, at a management cluster, definition of a test suite custom resource;
deploying, in response to the test suite custom resource, a first pod in the management cluster;
deploying, by the first pod, a second pod in a server of a first remote site of the remote sites;
checking, by the second pod, configuration of the server that includes an additional pod executing alongside the second pod, at least one virtual machine (VM) in which the second pod and the additional pod execute, a hypervisor configured to support the at least one VM, and a hardware platform on which the hypervisor executes; and
returning test data from the second pod to the first pod, the test data including results of the step of checking the configuration of the server.

9. The non-transitory computer readable medium of claim 8, wherein the management cluster executes in a data center remote from the remote sites, and wherein the management cluster includes a master server having a test controller configured to detect the test suite custom resource and to deploy the first pod based on the test suite custom resource.

10. The non-transitory computer readable medium of claim 9, wherein the test controller receives the test data from the first pod and stores the test data in a persistent volume attached to the test controller.

11. The non-transitory computer readable medium of claim 8, wherein the configuration of the server includes configuration of the additional pod.

12. The non-transitory computer readable medium of claim 8, wherein the configuration of the server includes configuration of at least one of container orchestrator support software or a guest operating system executing in the VM.

13. The non-transitory computer readable medium of claim 8, wherein the configuration of the server includes configuration of the hypervisor.

14. The non-transitory computer readable medium of claim 8, wherein the configuration of the server includes configuration of the hardware platform as determined from firmware of the hardware platform.

15. A virtualized computing system, comprising:
a data center in communication with remote sites over a network forming a distributed container orchestration system; and
a management cluster executing in the data center, the management cluster configured to:
receive a definition of a test suite custom resource;
deploy, in response to the test suite custom resource, a first pod in the management cluster;
deploy, by the first pod, a second pod in a server of a first remote site of the remote sites;
wherein the second pod is configured to check configuration of the server that includes an additional pod executing alongside the second pod, at least one virtual machine (VM) in which the second pod and the additional pod execute, a hypervisor configured to support the at least one VM, and a hardware platform on which the hypervisor executes; and
wherein the second pod returns test data to the first pod, the test data including results of the step of checking the configuration of the server.

16. The virtualized computing system of claim 15, wherein the management cluster executes in a data center remote from the remote sites, and wherein the management cluster includes a master server having a test controller configured to detect the test suite custom resource and to deploy the first pod based on the test suite custom resource.

17. The virtualized computing system of claim 15, wherein the configuration of the server includes configuration of the additional pod.

18. The virtualized computing system of claim 15, wherein the configuration of the server includes configuration of at least one of container orchestrator support software or a guest operating system executing in the VM.

19. The virtualized computing system of claim 15, wherein the configuration of the server includes configuration of the hypervisor.

20. The virtualized computing system of claim 15, wherein the configuration of the server includes configuration of the hardware platform as determined from firmware of the hardware platform.
